(19) United States
(12) Patent Application Publication
(10) Pub. No.: US 2024/0145698 A1
(43) Pub. Date: May 2, 2024

(54) Composite Cathode Material and Structure for All-Solid-State Batteries

(71) Applicants: Nissan North America, Inc., Franklin, TN (US); Nissan Motor Co., Ltd., Yokohama-shi (JP)

(72) Inventors: Hideyuki Komatsu, San Diego, CA (US); Shigemasa Kuwata, Palo Alto, CA (US); Balachandran Gadaguntla Radhakrishnan, Mountain View, CA (US); Kazuyuki Sakamoto, Kanagawa (JP)

(73) Assignees: Nissan North America, Inc., Franklin, TN (US); Nissan Motor Co., Ltd., Yokohama-shi (JP)

(21) Appl. No.: 17/978,754

(22) Filed: Nov. 1, 2022

(51) Int. Cl. H01M 4/525; H01M 4/04; H01M 4/38; H01M 4/62; H01M 10/0525; H01M 10/0562

(52) U.S. Cl. CPC H01M 4/525; H01M 4/0407; H01M 4/382; H01M 4/625; H01M 10/0525; H01M 10/0562; H01M 2004/021

(57) ABSTRACT

An all-solid-state battery (ASSB) cell has an anode comprising lithium metal, a solid electrolyte, and a cathode composite layer comprising cathode active material particles. Each cathode active material particle has a core of a first lithium transition metal oxide and a surface layer of a second lithium transition metal oxide, the second lithium transition metal oxide being different from the first lithium transition metal oxide. The second lithium transition metal oxide has a composition of LiNiₓMn_{y}Co_{z}O₂, wherein 0.40≤x≥0.82, 0.0≤y≥0.50, and 0.0≤z≥0.60 and x+y+z=1.

### TECHNICAL FIELD

This disclosure relates to cathode material for all-solid-state batteries, the cathode material designed to promote high ionic conductivity while imparting high stability at the cathode active material-solid electrolyte interface.

### BACKGROUND

Advances have been made toward high energy density batteries, using lithium metal as the anode material, and solid electrolytes to form all-solid-state batteries (ASSBs). Discovery of new materials and the relationship between their structure, composition, properties, and performance have advanced the field. However, even with these advances, batteries remain limited by the underlying choice of materials and electrochemistry. Among the components in ASSBs, the cathode active material may limit the energy density and dominate the battery cost.

Among the impediments to the practical application of ASSBs are the reactions occurring at the interface between the cathode active material and the solid electrolyte. There is a need to improve the stability between the solid electrolyte and the cathode active material while maintaining sufficient ionic conductivity between the materials.

### SUMMARY

Disclosed herein are implementations of all-solid-state battery (ASSB) cells having an anode comprising lithium metal, a solid electrolyte, and a cathode composite layer comprising cathode active material particles. Each cathode active material particle has a core of a first lithium transition metal oxide and a surface layer of a second lithium transition metal oxide, the second lithium transition metal oxide being different from the first lithium transition metal oxide. The second lithium transition metal oxide has a composition of LiNiₓMn_{y}Co_{z}O₂, wherein 0.40≤x≥0.82, 0.0≤y≥0.50, and 0.0≤z≥0.60 and x+y+z=1.

Also disclosed herein are implementations of a composite cathode material for an ASSB cell The composite cathode material has active material particles, a sulfide-based solid electrolyte, and a carbon additive. Each active material particle has a core of a first lithium transition metal oxide, a surface layer of a second lithium transition metal oxide, the second lithium transition metal oxide being different from the first lithium transition metal oxide, wherein the second lithium transition metal oxide has a composition LiNiₓMn_{y}Co_{z}O₂, wherein 0.40≤x≥0.82, 0.0≤y≥0.50, and 0.0≤z≥0.60 and x+y+z=1, and a lithium-containing coating layer covering defining a coated portion and an uncoated portion of the surface layer.

Variations in these and other aspects, features, elements, implementations, and embodiments disclosed herein are described in further detail hereafter.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is schematic of a cross-section of an ASSB cell.

FIG. 2 illustrates a cross-section of a cathode active material particle as disclosed herein.

FIG. 3 is a ternary contour diagram of the reaction energy at lithium metal oxide/solid electrolyte interfaces.

FIG. 4 is a schematic of a cathode layer showing a cathode active material particle in a solid electrolyte as disclosed herein.

FIG. 5 is a schematic of a cathode layer showing another cathode active material particle in a solid electrolyte as disclosed herein.

FIG. 6 is a schematic of a cathode layer showing yet another cathode active material particle in a solid electrolyte as disclosed herein.

### DETAILED DESCRIPTION

Advances have been made toward high energy density batteries, including both lithium metal and lithium-ion batteries. However, these advances are limited by the underlying choice of materials and electrochemistry. Traditional lithium-ion batteries either use organic liquid electrolytes, prone to negative reactions with active materials, or ionic liquid electrolytes, with increased viscosities and lower ionic conductivity. ASSBs can address some or all of these issues, as well as produce higher energy densities. However, the large interfacial resistance at the electrolyte/electrode interface and the interfacial stability and compatibility due to reactivity affect the electrochemical performance of ASSBs.

For ASSBs, electrode materials are those that reversibly insert ions through ion-conductive, crystalline materials. Conventional cathode active material consists of a transition metal oxide with the formula LiMOₓ, where M is one or more transition metals, which undergoes low-volume expansion and contraction during lithiation and dilithiation. The anode active material can be lithium metal, the low density of lithium metal producing a much higher specific capacity than traditional graphite anode active material.

While solid electrolytes show promise with the lithium metal anodes, and solid electrolytes have been developed with high ionic conductivities, the chemical, electrochemical and mechanical stabilities at the solid-solid interfaces present challenges. In particular, sulfide solid electrolytes have relatively poor intrinsic chemical and electrochemical stabilities against traditional transition metal oxide cathode materials.

To improve the chemical, electrochemical and mechanical stabilities at the cathode material-solid electrolyte interface, coatings have been used on the cathode material, mitigating to some degree the instabilities at the interface. However, the coating can be a rate-limiting factor for lithium ion conduction.

The composite cathode material disclosed herein balances the need for high ionic conductivity with the need for improved stability with the solid electrolyte. Disclosed are higher-capacity cathode materials with increased lithium ion conductivity, reversibly exchanging lithium ions quickly at higher potentials, while exhibiting improved stability at the solid electrolyte interface (SEI). The composite cathode active material disclosed herein combines material and structure to achieve higher capacities, faster chargeability and improved durability.

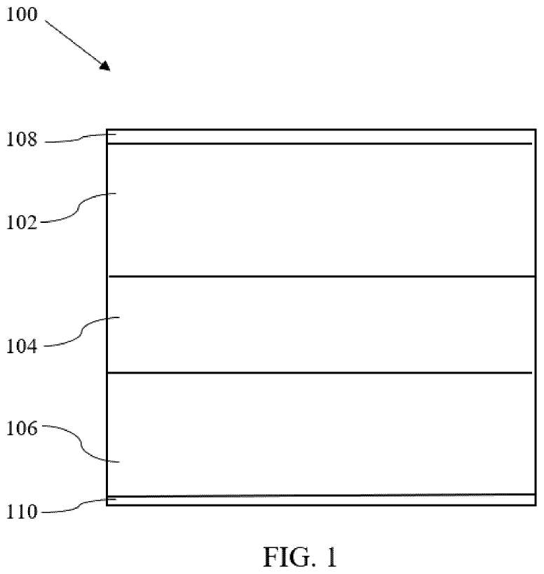

An ASSB cell 100 is illustrated schematically in cross-section in FIG. 1. The ASSB cell 100 of FIG. 1 is configured as a layered battery cell that includes as active layers a cathode composite layer 102 as described herein, a solid electrolyte 104, and an anode active material layer 106. In addition to the active layers, the ASSB cell 100 of FIG. 1 may include a cathode current collector 108 and an anode current collector 110, configured such that the active layers are interposed between the anode current collector 110 and the cathode current collector 108. In such a configuration, the cathode current collector 108 is adjacent to the cathode composite layer 102, and the anode current collector 110 is adjacent to the anode active material layer 106. An ASSB can be comprised of multiple ASSB cells 100.

The anode active material in the anode active material layer 106 can be a layer of elemental lithium metal, a layer of a lithium compound(s) or a layer of doped lithium. The anode current collector 110 can be, as a non-limiting example, a sheet or foil of copper, nickel, a copper-nickel alloy, carbon paper, or graphene paper.

The solid electrolyte 104 can be, as non-limiting examples, sulfide compounds (e.g. Argyrodite-type such as Li₆PS₅Cl, LGPS, LPS, etc.), garnet structure oxides (e.g. LLZO with various dopants), NASICON-type phosphate glass ceramics (LAGP), oxynitrides (e.g. lithium phosphorus oxynitride or LIPON), and polymers (PEO).

The cathode current collector 108 can be, as a non-limiting example, an aluminum sheet or foil, carbon paper or graphene paper.

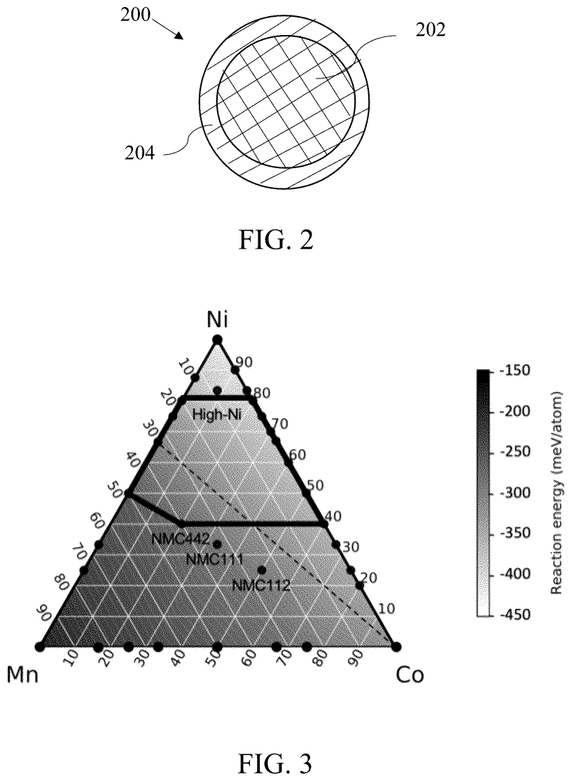

The cathode composite layer 102 includes the disclosed composite cathode material, comprised of individual active material particles having a multi-layer composition and a partial coating as further described. FIG. 2 is a schematic cross-section of a cathode active material particle disclosed herein. The cathode active material particle 200 has a core 202 of a first lithium transition metal oxide (double cross-hatch) and a surface layer 204 of a second lithium transition metal oxide (single cross hatch), the second lithium transition metal oxide being different from the first lithium transition metal oxide. Although only two layers are disclosed, it is contemplated that additional intermediate layers of lithium transition metal oxides can be incorporated.

The first lithium transition metal oxide of the core 202 is not particularly limited but is selected to optimize the capacity of the battery. Because the core 202 is not in direct contact with the solid electrolyte, concerns such as increased interfacial resistance and increased interfacial reactivity with the solid electrolyte can be addressed with the surface layer 204, leaving the first lithium transition metal oxide selection of the core 202 to be optimized for capacity and voltage range, for example. The first lithium transition metal oxide of the core 202 can be, for example, LiNiO₂, LiCoO₂, LiNi_{0.5}Mn_{0.5}O₂, LiNi_{1/3}Co_{1/3}Mn_{1/3}O₂, LiNi_{0.8}Co_{0.15}Al_{0.05}O₂, LiNi_{0.8}Mn_{0.1}Co_{0.1}O₂, LiNi_{0.6}Co_{0.2}Mn_{0.2}O₂, LiNi_{0.5}Mn_{0.3}Co_{0.2}O₂, LiMn₂O₄, LiMn_{1.5}Ni_{0.5}O₄, Li₂MnO₃, Li₂RuO₃, and Li₂MnO₃—LiMO₂ (where M=Ni, Co, Ni_{0.5}Mn_{0.5}, Ni_{1/3}Co_{1/3}Mn_{1/3} and Ru, so called lithium-rich materials or solid-solution materials).

The second lithium transition metal oxide of the surface layer 204 has been selected to minimize interfacial resistance upon cycling, interfacial reactivity and interfacial instability with the solid electrolyte. It has been found that ASSB cells using LCO and sulfide-based solid electrolytes exhibit increasing interfacial resistance upon cycling and poor cell characteristics compared to traditional liquid electrolyte cells. Further, there is a drive to reduce the cobalt content in cathode materials due in part to cost and availability. It has also been found that a high nickel content material with a solid electrolyte increases the interfacial reactivity at the interface. The second lithium transition metal oxide of the surface layer 204 as disclosed herein minimizes the interfacial mechanical, chemical and electrochemical instabilities with solid electrolytes, and particularly sulfide-based solid electrolytes.

FIG. 3 is a ternary contour diagram of the reaction energy at the interface between a sulfide-based solid electrolyte and LMO active material, with M being one or more of Ni, Mn and Co. The ternary contour diagram of the reaction energy at the interface was constructed using 32 existing LiNi_{y}Mn_{z}Co_{1-y-z}O₂ layered materials, including the three end members (LNO, LCO, and LMO), 24 binaries (Li—NiₓMn₁₋ₓO₂, LiMnₓCo₁₋ₓO₂, and LiCₓNi₁₋ₓO₂), and four ternary compositions. The heat map is obtained via interpolation from the computed reaction energies of the marked compositions. The dashed tie line connecting LCO and LiNi_{0.7}Mn_{0.3}O₂ indicates a trend line of reducing the cobalt in the cathode active material while maintaining similar chemical stability as that of LCO. A key take-away from the mapping of the reaction energies is that there is an inherent trade-off between the overall drive toward reducing the cobalt content in cathode active material and the interfacial stability with solid electrolytes such as sulfide-based solid electrolytes. The higher nickel content leads to higher interfacial reactivity with the sulfide-based solid electrolytes.

The surface layer 204 of the disclosed composite cathode active material particle is composed of a material with a composition represented by the area enclosed in the thick black lines of FIG. 3. The composition of the surface layer 204, or the second lithium transition metal oxide, is LiNiₓMn_{y}Co_{z}O₂, wherein 0.40≤x≥0.82, 0.0≤y≥0.50, and 0.0≤z≥0.60 and x+y+z=1. In some embodiments, in the composition of the second lithium transition metal oxide of the surface layer 204, 0.40≤x≥0.70, 0.20≤y≥0.30, and 0.0≤z≥0.40. This is represented by the dashed tie line within the black outlined area. In some embodiments, in the composition of the second lithium transition metal oxide of the surface layer 204, x=0.70 and y=0.30. With any of these embodiments, the first lithium transition metal oxide of the core 202 can have a nickel content of at least 80%, as there is no interface between the core and the solid electrolyte.

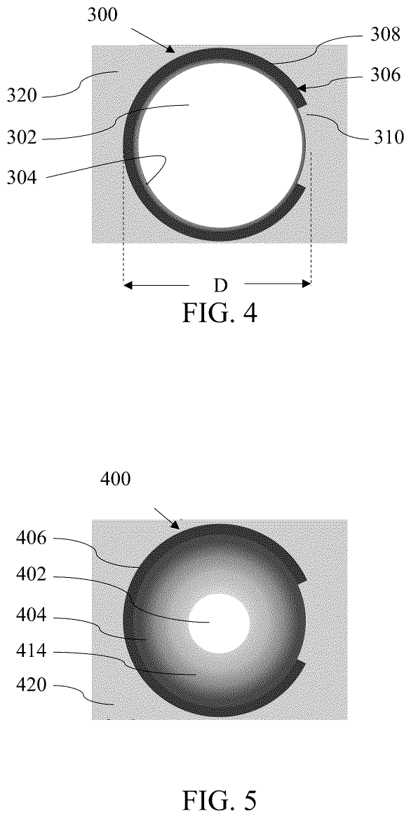

FIGS. 4 and 5 are cross-sectional views that illustrate other aspects of the composite cathode active material particles and composite cathode layers disclosed herein. FIG. 4 represents a cathode active material particle 300 in the cathode composite layer 102, which further includes a solid electrolyte 320, sometimes referred to as a catholyte, as it is a solid electrolyte in the cathode layer. The cathode composite layer 102 can further include a carbon additive mixed in with the solid electrolyte and the carbon active material particles, not shown. FIG. 5 also represents a cathode active material particle 400 in the cathode composite layer 102, which further includes the solid electrolyte 420. In FIG. 5, the surface layer 404 is thicker than that of the surface layer 304 in FIG. 4, and the illustrated gradient 414 in black to white represents one or more intermediate layers of LiNi_{y}Mn_{z}Co_{1-y-z}O₂ layered materials between the surface layer 404 and the core 402.

The surface layer 204, 304, 404 can have a thickness T of ≥10 nm. The thickness T of the surface layer 204, 304, 404 can also be ≤10% of a diameter D (shown in FIG. 4) of the cathode active material particle 200, 300, 400.

Because the surface layer 204, 304, 404 is composed of material that exhibits some reaction energy at the SEI interface, the cathode active material particles can further have a coating layer 306, 406 partially coating the surface layer 304, 404 to provide further stability to the particle. The coating layer 306, 406 material is lithium-based material that is stable with the solid electrolyte. The coating material can be Li₂O—ZrO₂ (Li₂ZrO₃), LiNbO₃, LiAlO₂, Li₃PO₄, Li₂CO₃, Li₂O, LiOH, Li₄Ti₅O₁₂, Li₂SiO₃, Li₂PNO₂, Li₃YCl₆, Li₃YB₆, Li₇La₃Zr₂O₁₂, Li₂La₂Ti₃O₁₀, as examples.

Coating material can be rate limiting for lithium ion conduction. Therefore, the coating layer 306, 406 only partially coats the surface layer 304, 404 of the cathode active material particle 300, 400. Disclosed is a coating structure that is found to be successful in balancing interface stability and lithium ion conduction, providing a cathode material that is particularly suited for durability and quick charge capabilities. The coating layer 306, 406 forms a “Pac-man” like structure, having a coated portion 308 and an uncoated portion 310, with the uncoated portion 310 represented as the “mouth” of the Pac-man. In other words, the uncoated portion 310 is a continuously uniform portion, with only one uncoated portion on the particle. To optimize the stability and capacity of the cathode material, the amount of coated portion 308 versus uncoated portion 310 varies depending on the composition of the surface layer and its reaction energy at the electrolyte interface, which exists all along the uncoated portion 310. The coated portion 308 is at least a percentage of a surface area of the surface layer, the percentage determined by %=(150x+75y)/150, the x and y taken from the composition of the second lithium transition metal oxide of the surface layer 302, 402. For example, if the composition of the surface layer is LiNi_{0.4}Mn_{0.4}Co_{0.2}O₂, the coated portion 308 is 60% of the surface area of the surface layer, making the uncoated portion 310 40%. As another example, if the composition of the surface layer is LiNi_{0.7}Mn_{0.3}O₂, the coated portion 308 is 85% of the surface area of the surface layer, making the uncoated portion 310 15%.

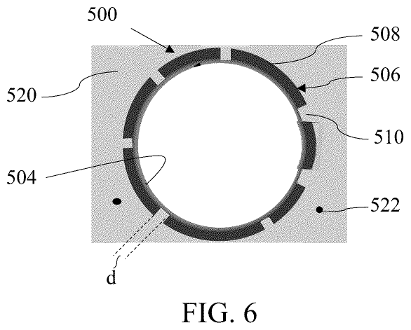

Alternative to the Pac-man like structure of the coating layer 306, 406, the coating layer 506 can have multiple openings, or uncoated portions 510. The combined surface area of the uncoated portions versus the coated portion 508 is calculated using the equation above. To optimize the ion conductivity with multiple openings, with their smaller size, each opening of the uncoated portion has a diameter d equal to or larger than a particle diameter of the carbon additive 522, whether the carbon additive is carbon particles or carbon fibers. This is represented in FIG. 6, which shows the cathode active material particle 500 in the solid electrolyte 520. The surface layer 504 interfaces with the solid electrolyte 520 at the uncoated portions 510.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An all-solid-state battery (ASSB) cell, comprising:
an anode comprising lithium metal;
a solid electrolyte; and
a cathode composite layer comprising cathode active material particles, a cathode active material particle comprising:
a core of a first lithium transition metal oxide; and
a surface layer of a second lithium transition metal oxide, the second lithium transition metal oxide being different from the first lithium transition metal oxide, wherein the second lithium transition metal oxide has a composition of LiNiₓMn_{y}Co_{z}O₂, wherein 0.40≤x≥0.82, 0.0≤y≥0.50, and 0.0≤z≥0.60 and x+y+z=1.

2. The ASSB cell of claim 1, wherein, in the composition of the second lithium transition metal oxide, 0.40≤x≥0.70, 0.20≤y≥0.30, and 0.0≤z≥0.40.

3. The ASSB cell of claim 2, wherein the first lithium transition metal oxide has a nickel content of at least 80%.

4. The ASSB cell of claim 1, wherein the first lithium transition metal oxide has a nickel content of at least 80%.

5. The ASSB cell of claim 1, wherein x=0.70 and y=0.30.

6. The ASSB cell of claim 1, wherein the solid electrolyte is a sulfide-based solid electrolyte.

7. The ASSB cell of claim 6, wherein the solid electrolyte is Li₆PS₅CL.

8. The ASSB cell of claim 1, wherein the surface layer has a thickness of ≥10 nm.

9. The ASSB cell of claim 8, wherein the thickness of the surface layer is ≤10% of a diameter of the cathode active material particle.

10. The ASSB cell of claim 1, wherein the cathode active material particle further comprises a coating layer on the surface layer of the cathode active material particle that only partially covers the surface layer, forming a coated portion and an uncoated portion.

11. The ASSB cell of claim 10, wherein the coated portion is at least a percentage of a surface area of the surface layer, the percentage determined by %=(150x+75y)/150.

12. The ASSB cell of claim 10, wherein the uncoated portion is a continuous uncoated portion.

13. The ASSB cell of claim 10, wherein the cathode composite layer further comprises a carbon additive, and wherein the uncoated portion of the coating layer is formed of multiple openings, each opening having a diameter equal to or larger than a particle diameter of the carbon additive.

14. The ASSB cell of claim 10, wherein the coating layer contains lithium.

15. A composite cathode material for an ASSB cell, the composite cathode material comprising:
active material particles;
a sulfide-based solid electrolyte; and
a carbon additive, wherein an active material particle comprises:
a core of a first lithium transition metal oxide;
a surface layer of a second lithium transition metal oxide, the second lithium transition metal oxide being different from the first lithium transition metal oxide, wherein the second lithium transition metal oxide has a composition LiNiₓMn_{y}Co_{z}O₂, wherein 0.40≤x≥0.82, 0.0≤y≥0.50, and 0.0≤z≥0.60 and x+y+z=1; and
a lithium-containing coating layer covering defining a coated portion and an uncoated portion of the surface layer.

16. The composite cathode material of claim 15, wherein, in the composition of the second lithium transition metal oxide, 0.40≤x≥0.70, 0.20≤y≥0.30, and 0.0≤z≥0.40.

17. The composite cathode material of claim 16, wherein the first lithium transition metal oxide has a nickel content of at least 80%.

18. The composite cathode material of claim 15, wherein the solid electrolyte is Li₆PS₅CL.

19. The composite cathode material of claim 15, wherein the surface layer has a thickness of ≥10 nm and ≤10% of a diameter of the active material particle.

20. The composite cathode material of claim 15, wherein the coated portion is at least a percentage of a surface area of the surface layer, the percentage determined by %=(150x+75y)/150.
